(19) United States
(12) Patent Application Publication
(10) Pub. No.: US 2025/0383236 A1
(43) Pub. Date: Dec. 18, 2025

(54) THERMAL PROPERTY MEASUREMENT SYSTEMS AND METHODS FOR ELECTRONICS

(71) Applicant: Purdue Research Foundation, West Lafayette, IN (US)

(72) Inventors: Aalok U. Gaitonde, Cupertino, CA (US); Amy M. Marconnet, West Lafayette, IN (US); Justin A. Weibel, West Lafayette, IN (US)

(73) Assignee: Purdue Research Foundation, West Lafayette, IN (US)

(21) Appl. No.: 19/220,736

(22) Filed: May 28, 2025

Related U.S. Application Data
(60) Provisional application No. 63/653,328, filed on May 30, 2024.

(51) Int. Cl. G01J 5/00; G01J 5/48; G01N 25/18

(52) U.S. Cl. CPC G01J 5/0007; G01J 5/485; G01N 25/18; G01J 2005/0077; G01J 2005/0092

(57) ABSTRACT

A metrology system may measure thermal conductance across an interface between a first material layer bonded to a second material layer. The first material layer may include a first outward facing and the second material layer may include a second outward facing surface. The system may include a heating source which provides periodically varying heat across the first outward facing surface, and a heat sink in contact with the second outward facing surface. The system may further include a first thermal measurement device configured to measure a temperature of the first outward facing surface, and a second thermal measurement device configured to measure a temperature of the second outward facing surface. The system may generate, based on a plurality of measurements acquired over time, a thermal conductance measurement across the interface between the first material layer bonded to the second material layer.

### CROSS REFERENCE TO RELATED APPLICATIONS

This application claims the benefit of U.S. Provisional Application No. 63/653,328 filed May 30, 2024, the entirety of which is hereby incorporated by reference.

### TECHNICAL FIELD

The present application relates to electronic devices, and specifically to systems and methods that measure bulk and interfacial thermal properties of electronic devices such as semiconducting substrates and deeply situated interfaces (or bonds) between layers within vertically integrated semiconductor packages.

### BACKGROUND

Semiconductor dies, also known as chips, are small blocks of semiconducting material, typically silicon, that contain integrated circuits. These dies are fundamental components in modern electronic devices, enabling the processing and storage of data. Vertically stacking these dies, a technique known as 3D integration, offers several advantages. It increases the density of components, which can enhance performance and reduce power consumption and latency by shortening the distance between circuit elements. This stacking also allows for more functionalities to be integrated into a single package, potentially reducing the overall footprint of the device and enabling more compact and efficient designs. However, vertical stacking introduces significant thermal management challenges. The close proximity of multiple active layers generates substantial heat, which is harder to dissipate compared to traditional single-layer designs. Efficient heat dissipation is crucial to maintain the reliability and performance of the stacked dies, necessitating advanced cooling techniques and materials to manage the increased thermal load effectively. Quantifying the thermophysical properties of the materials and interfaces is critical to ensuring that the devices operate at safe temperatures for performance and long term reliability.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a first example of a metrology system for measuring the thermal conductance of the bond between a two-layer silicon stack.

FIG. 2 illustrates a second example of a metrology system for measuring thermal conductance with a 1D gradient technique.

FIG. 3A shows a representative example dataset of the steady periodic temperature oscillations of the bottom and top surfaces of the silicon from numerical experiments performed with the radial spreading concept.

FIG. 3B shows data for the same boundary conditions and power input but with a finite interfacial resistance at the interface.

FIG. 3C shows absolute amplitude differences for a representative example dataset of steady periodic temperature oscillations of the bottom and top surfaces of the silicon.

FIG. 3D shows relative amplitude differences for a representative example dataset of steady periodic temperature oscillations of the bottom and top surfaces of the silicon.

FIG. 4A shows the absolute amplitude as a function of radius for different values of Rₜₕ.

FIG. 4B shows relative amplitude differences as a function of radius for different values of Rₜₕ.

FIG. 5A depicts a graphical plot of select results from a comparison of the radial spreading measurement technique versus the 1D gradient measurement technique through numerical experiments performed on a two-layer silicon stack.

FIG. 5B depicts a graphical plot of select results from the comparison of FIG. 5A, showing the absolute amplitude difference.

FIG. 5C depicts a graphical plot of select results from the comparison of FIG. 5A, showing the relative amplitude difference for both measurement techniques as a function of contact resistance.

FIG. 6 illustrates a third example of a metrology system configured for measuring deeply buried thermal interfaces with low magnitudes of contact resistances.

FIG. 7 shows representative temperature profiles for the top and bottom 154 surface of the sample in the example shown in FIG. 6, in response to the periodically varying heating power.

FIG. 8A depicts an overview of an experimental measurement system configured to measure interfacial thermal resistance between two bonded material layers of a sample.

FIG. 8B depicts a schematic sectional view of a subset of the experimental measurement system of FIG. 8A.

FIG. 8C depicts a photographic overview of an assembled subset of the experimental measurement system of FIG. 8A, showing portions including the toggle clamps, spring loaded plunger assembly, and the adapter plates.

FIG. 9 illustrates a fourth example of a metrology system.

FIG. 10 illustrates an example of computing hardware of a metrology system.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Introduction

Scaling challenges in the semiconductor industry posed by conventional two-dimensional (2D) dies can be addressed in part by stacking dies in the vertical direction. Advanced packaging technologies such as hybrid and fusion bonding allow heterogeneous integration, where various chiplets are bonded together to create a single system-on-chip (SoC) device. The primary advantage of multi-layer stacking is shorter interconnects, lower latency between chips, higher bandwidth, and a path toward miniaturization. The interfaces between multi-layer and monolithically bonded dies, and those found in other high-performance thermal interfaces, have a low magnitude of thermal interfacial resistance (Rₜₕ) of the order of 0.01 cm² K/W or less. The depth of such interfaces varies from a few nanometers to a few hundred microns, depending on the number of layers and the thickness of each individual die. When low magnitude interfacial resistances are buried deep below the exposed surface, Rₜₕ can be challenging to characterize using conventional thermal measurement techniques. A dual modulation frequency time-domain thermoreflectance (TDTR) based technique has been presented which is able to measure the spatial variation of very low values of Rₜₕ, of the order of 0.0001 cm² K/W. However, this technique is limited to the characterization of interfaces that are within a few hundred nanometers from the exposed surface of the sample due to limitations on the thermal penetration depths of pump-probe based techniques. A periodic heating method coupled with lock-in thermography has also been presented to characterize deeply buried interfaces, where the amplitude and phase lag of the temperature oscillations at the contact interface are used to estimate Rₜₕ. However, this measurement technique requires dicing of the sample so that the exposed cross-section can be measured using infrared microscopy. Other steady-state techniques such as the conventional reference bar method are infeasible for measuring small values of Rₜₕ due to the challenges in resolving very small jumps in temperature at the contact interfaces.

As such, there is a broadly recognized need to develop characterization techniques that can non-destructively measure deeply buried interfaces that have a very low value of concepts to characterize Rₜₕ in the range of 0.001 to 0.01 cm² K/W buried 100s μm from the exposed surface of a two-layer bonded silicon stack. The general approach in both concepts is to measure the temperature of both sides of a bonded stack in response to a periodic heat input to extract Rₜₕ.

### II. Exemplary Thermal Conductance Metrology Methods

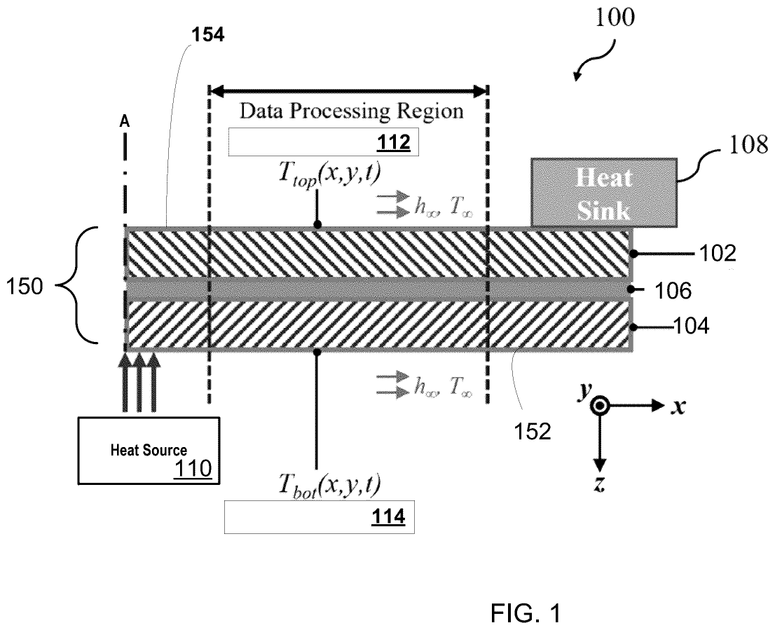

Described below are two concepts for non-contact measurements of low-thermal-resistance and buried interfaces, as shown in FIGS. 1A and 1B.

### A. Non-Contact Thermal Conductance Measurements Using Radial Spreading Techniques

FIG. 1 illustrates a first example of a metrology system for measuring the thermal conductance of the bond between a two-layer silicon stack. FIG. 1 provides an axisymmetric view about axis A of the two-layer bonded silicon stack 150. The two-layer bonded silicon stack 150 includes a first layer 102 having an outer surface 154, a second layer 104 having an outer surface 152, and an intermediate bond layer 106 that has some associated interfacial thermal resistance, Rₜₕ.

For ease of discussion, and in reference to FIG. 1 the first layer 102 is referred to as a top layer and the second layer 104 is referred to as the bottom layer.

The system may include a heat sink 108 and a heat source 110. The outer surface 154 of the top layer 102 may be placed on the heatsink 108. The outer surface 152 of the bottom layer may be subjected to the heat source 110. However, it should be appreciated that in other embodiments, the heat source 110 may be applied to top layer 102 the heat sink 108 may be applied to the bottom layer 104. As a convention in this disclosure, the layer receiving the heat source 110 will be referred to as the first layer 102 and the layer receiving the heat sink will be referred to as the second layer 104.

In FIG. 1, the heat sink 108 and heat source 110 are directed at the outer surfaces to provide radial spreading. The center of one face of a sample is subjected to a periodically varying heat input, while the edge of the opposite face of the sample is held at a constant temperature using the heat sink 108. In some examples, the heat sink 108 may be temperature controlled via integrated fluid flow or thermoelectric cooling, which would keep the portion of the sample in contact with the heatsink at an approximately constant temperature and ensuring the system reaches steady state efficiently.

In a region of the sample stack between the two vertical dotted lines, between from the heat source and the heat sink 108, heat flow is directed primarily in the radial direction X relative to the stack 150. The temporal and spatial temperature distribution of both the top 102 and bottom 104 layers of silicon within this region.

The system 100 may include a first thermal measurement device 112 and a second thermal measurement device 114. Each of these devices may be capable of measuring a temperature and/or infrared intensity of the respective outer surfaces 154, 152. In the example shown in FIG. 1, the thermal measurement devices 112 and 114 may be high-resolution infrared cameras directed at the surface regions between the heat source and heat sinks along the radial direction X may be measured simultaneously.

The heat source 110 may provide periodic heat input with, for example, a non-contact heat source. The non-contact heat source may include, for example, lasers or high powered light-emitting diodes (LEDs). For optically transparent/semi-transparent or reflective samples, an absorber disk (not shown) may be adhered to the bottom layer 104. The absorber disk could consist of a carbon tape or a metallic tape coated with a high absorptivity material like graphite. Alternatively, the heat source may be in contact with the bottom layer 104 and may include electrical resistance heaters or thermoelectric devices.

The heat source 110 may provide periodic heat input, which means that the sample is heated for a period of time and then let to cool down for a period of time. The periodic heat input may be a pulse train or square wave (where the heat is on for a period of time and off for a period of time such as achieved by turning on and off an electrical resistance heater or by chopping or modulating the intensity of a laser beam), sinusoidal and include active heat removal (for instance, if a thermoelectric device is used to provide heating), or any other time-periodic signal. The fundamental frequency of the heating signal is typically used for analysis, although for the pulse train or arbitrary time-periodic signals, other harmonic signals could be analyzed.

If the thermophysical properties of the bulk silicon layers 102 and 104 are known, the unknown interfacial thermal resistance (Rₜₕ) can then be extracted using the associated amplitude and phase differences across the two exposed faces of the stack as a function of radius, by using a physics-based model to solve the governing heat diffusion equation for a material that undergoes periodic heating.

### B. Thermal Conductance Measurements Using 1D Gradient Techniques

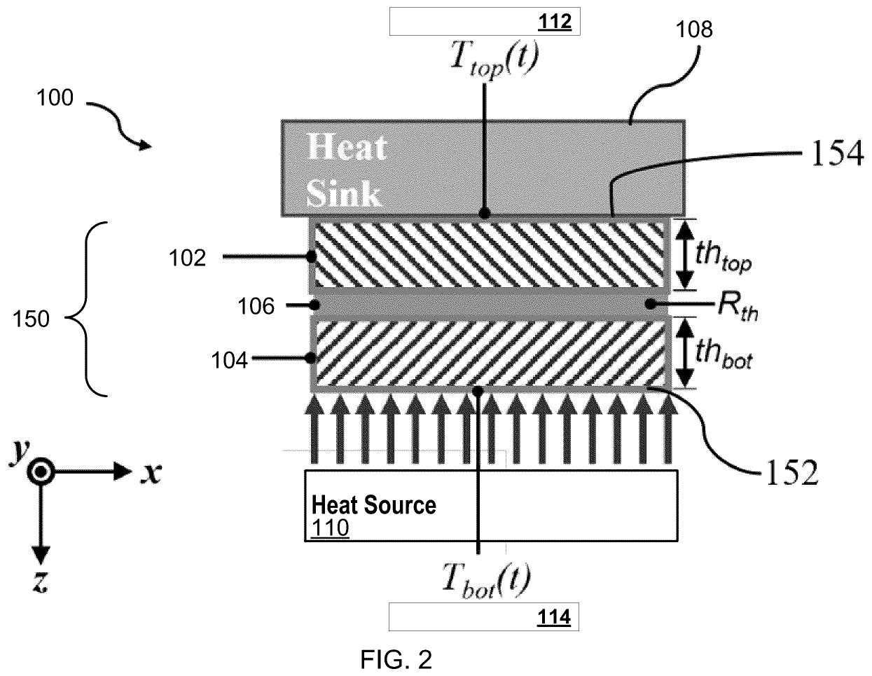

FIG. 2 illustrates a second example of a metrology system for measuring thermal conductance with a 1D gradient technique. In this example, a uniform transient thermal gradient is established across the sample stack 150 with respect to the Z direction. The outer surface (152) the bottom layer 104 is heated uniformly using a periodically varying heat source, while the outer surface (154) is maintained at a colder temperature by attaching a heat sink (108).

The heat source 110 may provide heat to the bottom surface 152. The heat source 110 and heatsink 108 may be similar to the embodiment described in FIG. 1 except that heat is applied uniformly across an entirety of the outer surface 152 of the bottom layer 104 and the heat sink 108 is applied uniformly across an entirety of the top surface 154. A high absorptivity coating may be applied to the outer surfaces 152 and 154 for transparent, semi-transparent, or reflective materials.

Thermal measurement devices 112 and 114 may be oriented at the top and bottom of the stack 150. Because there is no lateral temperature variation in theory, single-point measurements could be performed using infrared pyrometry at the bottom (T_{bot}(t)) and top surfaces (Tₜₒₚ(t)) or an infrared camera can be used to obtain spatially averaged data. At the heated bottom surface 152, both heating and temperature measurements can be performed simultaneously because of the optical heating and sensing, while temperature measurements of the top surface 154 must be performed though a small aperture or opening (not shown) in the heat sink 108 or by fabricating heat sinks transparent to the wavelength used for the non-contact temperature sensor (e.g., materials transparent in the infrared when using infrared temperature sensing such as sapphire, calcium fluoride, or germanium) and the cooling fluid must meet the same criteria.

Similar to the radial spreading technique of FIG. 1, the unknown interfacial thermal contact resistance (Rₜₕ) can be extracted using the amplitude and phase differences across the two faces 152 and 154, by using a known solution to the heat diffusion equation for a material exposed to periodic heating.

### III. Numerical Experimentation of the Exemplary Thermal Conductance Metrology Concepts

To prove the feasibility of the above measurement techniques, numerical experiments were performed using COMSOL Multiphysics. A 2D axisymmetric model geometry containing the boundary conditions is simulated, including the two-layer silicon sample and the heat sink.

For the radial spreading concept, the boundary conditions are as shown in FIG. 1. A periodic heat flux is assigned to a central spot of diameter ˜500 μm of the sample with the functional form

$${q}^{″} ( t ) = {q}_{0}^{″} ( 1 + sin ( 2 π f t ) ) ,$$

where

$${q}_{0}^{″}$$

is the laser heat flux, f is the periodic heating frequency, and tis time. The magnitude of

$${q}_{0}^{″}$$

is set at 5 W. The diameter of the sample is 10 mm, and the heat sink boundary condition is applied to the outer edge of the top silicon region (as shown in FIG. 1). The thickness of each of the two silicon layers is set to 350 μm. The bulk thermophysical properties for the silicon including the density ρ, specific heat Cₚ, and thermal conductivity k are specified as inputs to the model. The magnitude of the interfacial resistance Rₜₕ is also specified as an input. The model is run for at least ˜50 cycles to ensure that the system reaches a steady time-periodic state. A free tetrahedral mesh is used, with the maximum mesh size in the sample domain set to 100 μm. The time-step in the transient solver in COMSOL is set to 0.1 s. The output of this model is the transient temperature distribution from both the top (Tₜₒₚ(x, y, t)) and the bottom faces (T_{bot}(x, y, t)) of the silicon in the region away from the heat source and heat sink, which is then imported into MATLAB for further analysis.

For the 1D concept, similar numerical experiments are performed using a sample of diameter 5 mm, consisting of 2 individual 350 μm silicon layers. A convective heat flux boundary condition with an effective convective coefficient of 100,000 W/m²K at 10 degrees C. is assigned to the top surface of the top silicon layer to mimic heat removal from the heat sink. The incident laser power on the bottom face on the sample was varied until the maximum temperature in the sample with the 1D gradient concept was approximately equal to the maximum temperature of the radial spreading concept.

### A. Data Processing: Absolute and Relative Amplitude Differences

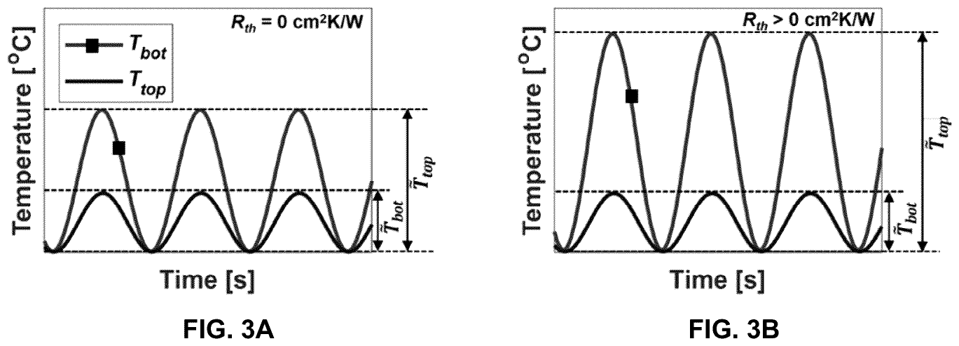

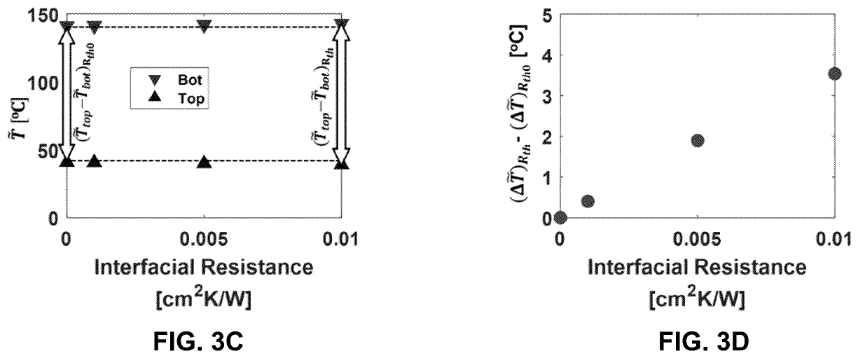

FIG. 3A shows a representative example dataset of the steady periodic temperature oscillations of the bottom (T_{bot}) and top surfaces (Tₜₒₚ) of the silicon from numerical experiments performed with the radial spreading concept. These data shown in FIG. 3A are for a two-layer silicon stack that has no interfacial thermal resistance, Rₜₕ=0 cm² K/W. The bottom surface (T_{bot}) shows a higher temperature oscillation amplitude compared to the top surface (Tₜₒₚ) because the incident periodic heat input is absorbed on the bottom silicon. FIG. 3B shows data for the same boundary conditions and power input but with a finite interfacial resistance at the interface, Rₜₕ=0.1 cm² K/W. With this increased interfacial thermal resistance, T_{bot} demonstrates a higher oscillation amplitude. Here, the difference in the curves between FIGS. 3A and 3B is exaggerated for clarity. The difference between the maximum and minimum temperature (i.e., twice the amplitude of oscillation) of the bottom and top surfaces is defined as \tilde{T}_{bot} and \tilde{T}ₜₒₚ, respectively, as is indicated in FIGS. 3A and 3. For any given model and at each point in the sample domain, Δ\tilde{T}_{Rth}=(\tilde{T}ₜₒₚ−\tilde{T}_{bot})_{Rth} is the absolute amplitude difference between \tilde{T}_{bot} and \tilde{T}ₜₒₚ.

The sensitivity of this measurement technique can be evaluated by comparing the absolute amplitude difference for a case with a finite contact resistance Δ\tilde{T}_{Rth} to that with no contact resistance Δ\tilde{T}_{Rth0}. This difference in the absolute amplitude differences is defined as the relative amplitude difference=Δ\tilde{T}_{Rth}−Δ\tilde{T}_{Rth0}. The measurement sensitivity to Rₜₕ is related to the relative amplitude difference, and a higher relative amplitude difference is desirable. For an example dataset, the absolute amplitude differences are shown in FIG. 3C, and the relative amplitude differences are shown in FIG. 3D, each for various levels of Rₜₕ.

### IV. Discussion of the Exemplary Thermal Conductance Metrology Concepts

### A. Discussion of the Radial Spreading Measurement Techniques

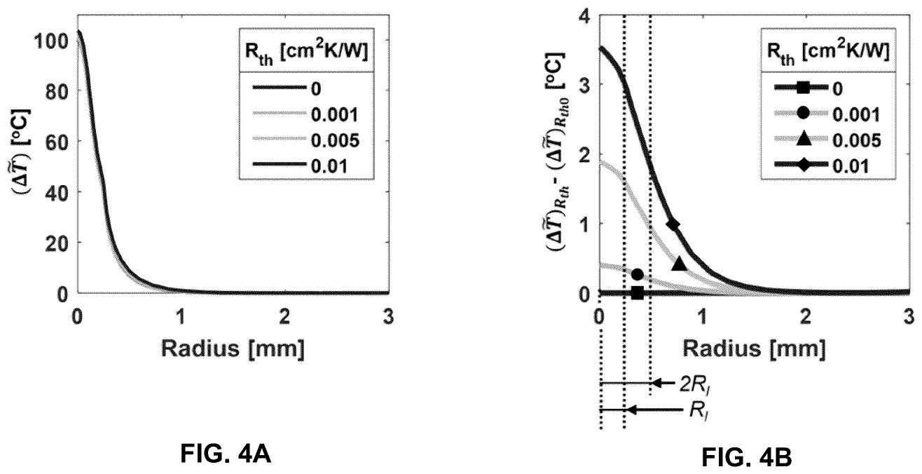

For the radial spreading technique, the results of numerical experiments performed for a two-layer 10 mm wide silicon sample with a power input of 5 W incident (with the laser spot diameter being 500 μm) at the center of the sample are presented. Each layer of silicon is 350 μm thick, with a total stack height of 700 μm. At the contact interface, the specified value of Rₜₕ ranges from 0 to 0.01 cm² K/W. The heat sink at the outer edge of the sample is set at a constant 20 degrees C. FIG. 4A shows the absolute amplitude and FIG. 4B shows relative amplitude differences as a function of radius for different values of Rₜₕ. Note that although the absolute amplitude differences (Δ\tilde{T}) in FIG. 4A show a high value near the center of the sample, the relative differences are relatively low, and the differences quickly decay to near zero within ˜1.5 mm from the center of the sample. For example, in the suspended region of the sample at a radial distance twice that of the laser spot diameter (R=2Rₗ), the measurable difference in amplitude for a sample with a Rₜₕ of 0.01 cm² K/W is less than 2 degrees C., and even lower for smaller values of Rₜₕ. Such low values of temperature differences present a challenge to measure accurately using infrared detectors.

Furthermore, while the temperature difference could be increased by increasing the power input, there may be practical limits on the material temperature. This radial spreading configuration leads to a high magnitude of Δ\tilde{T} at the center of the sample, where heat is absorbed by the sample, and the undesirable rapid decay along the radius. These drawbacks led to the conceptualization of the 1D gradient technique that is discussed in the following subsection. To ensure a fair comparison between the approaches, assessment of the 1D gradient is performed at laser power that leads to the same peak sample temperatures.

### B. Discussion of the 1D Gradient Measurement Techniques

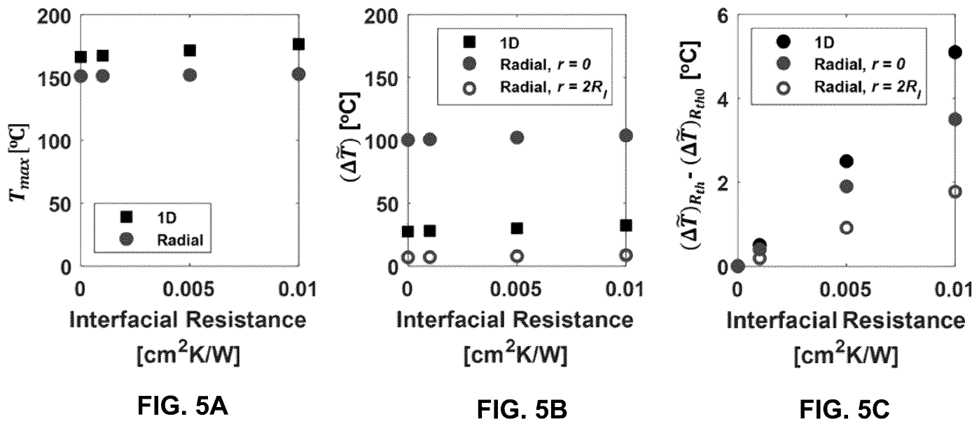

As noted above, to compare the two concepts in a fair manner, the power applied in the 1D analysis is adjusted to such that the maximum sample temperatures approximately match the radial spreading case (see, FIG. 5A). The power level for the 1D gradient simulations is 100 W, applied uniformly across the bottom face of the sample of diameter 5 mm. FIG. 5B shows the absolute amplitude difference ((Δ\tilde{T}) Rₜₕ), and FIG. 5C shows the relative amplitude difference for both concepts. The 1D technique provides a higher measurable temperature signal compared to the radial spreading concept. At an Rₜₕ of 0.01 cm² K/W, the measurable relative amplitude difference for the 1D concept is ˜5 degrees C., while that in the suspended region of the radial spreading approach is <2 degrees C. Another advantage of the 1D concept is that local (i.e., point) temperature measurements of the bottom and top layers are sufficient, as opposed to the need to measure the spatially varying temperature distribution in the radial spreading concept.

Accordingly, data from these simulations for a two-layer silicon stack of total thickness 700 μm demonstrate the higher sensitivity of the 1D technique in comparison to the radial spreading technique. An additional distinguishing factor is that the radial spreading technique requires high resolution spatial temperature mapping, while only point measurements are sufficient for the 1D gradient concept.

### V. Exemplary Thermal Conductance Metrology Systems

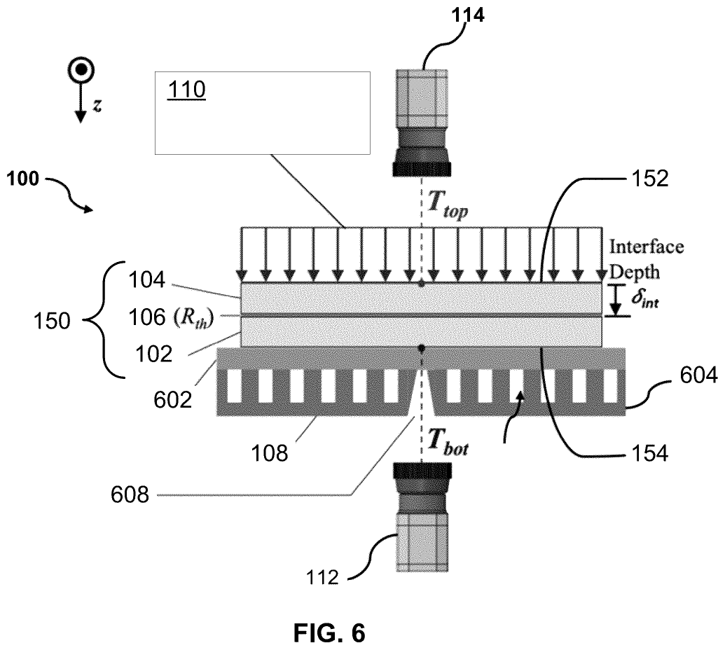

FIG. 6 illustrates a third example of a metrology system 100 configured for measuring deeply buried thermal interfaces with low magnitudes of contact resistances. The general approach includes creating a periodically varying temperature gradient across a bonded sample stack 150, comprising a first material layer 102 and a second material layer 104 separated by a bond layer 106, and measuring the amplitude difference and phase delay across the two faces 152 and 154 of the respective layers 104 and 102 to extract the unknown interfacial thermal boundary resistance (Rₜₕ). A uniform transient thermal gradient is established across the sample stack 150 by heating one face 152 of the sample uniformly using a non-contact periodically varying heat source. The opposite face 154 of the sample stack 150 is maintained at a cooler temperature by attaching it to a heat sink 108.

The first thermal measurement device 112 and a second thermal measurement device 114 may measure the temperatures across the faces 154 and 152. Theoretically, there is no lateral temperature variation, and point-based measurements could be made using IR point pyrometry at the bottom (T_{bot}(t)) and top surfaces (Tₜₒₚ(t)). Practically, IR cameras may be preferred since they could be used to measure spatially averaged data to minimize noise in the measurement.

At top surface 152 of the sample 150, both heating and temperature measurements are performed simultaneously because of the optical heating and sensing, but temperature measurements of the bottom cooled surface 154 are more challenging due to the heat sink 108. To overcome this challenge, the heat sink 108 may include an IR-window 602 that is transparent in the spectrum in which the IR cameras are sensitive. As an example, for IR cameras sensitive in the long-wave IR spectrum of ˜7-14 μm, Germanium may be an acceptable choice due to its ˜>95% transmission in this wavelength range and relatively high thermal conductivity. The heat sink also includes a copper portion 604 with integral microchannels 606, and an aperture 608 (e.g., of ˜1 mm in diameter).

Their IR transparent window 602 may be positioned between the heat sink and the copper portion 604. The IR transparent window 602 and the copper portion 604 with the microchannels 606 are clamped together to form the heat sink 108. Temperature measurements performed by IR imaging across this IR-window 602 and aperture 608 directly measure the surface 154, T_{bot}(t), bypassing the interfacial thermal resistance between the heat sink 214 and the bottom layer 102 of the sample 150. Hence, effects of this interfacial resistance between the bottom layer 102 of the sample 150 and the heat sink 214 will not affect the thermal analysis.

The dimensions of the IR-transparent window 602 and the diameter of the aperture 608 are designed such that the temperature uniformity and one-dimensional nature of heat transfer across the sample stack 212 is maintained.

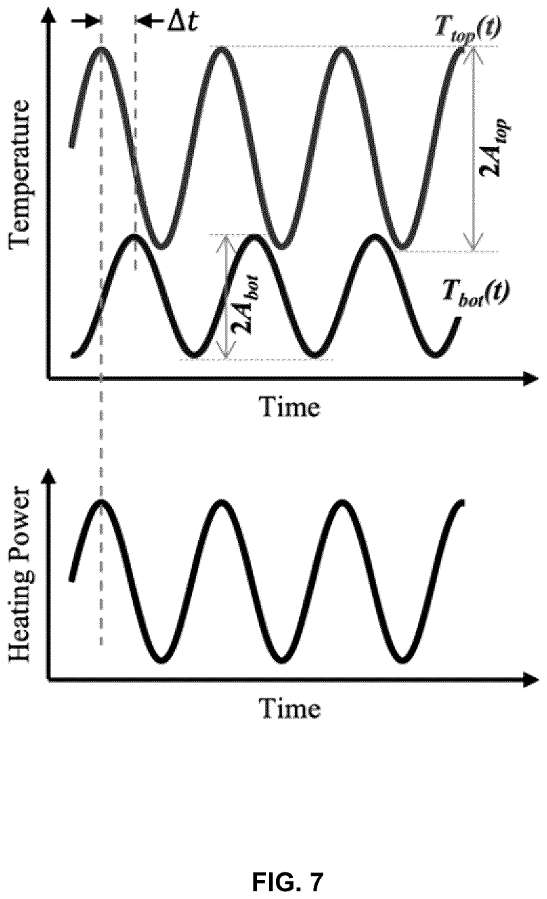

FIG. 7 shows representative temperature profiles for the top 152 and bottom 154 surface of the sample 150 in the example shown in FIG. 6, in response to the periodically varying heating power. Assuming the bulk thermophysical properties of the individual layers of the sample 150 are known, the unknown Rₜₕ between the two stacked layers 102 and 104 can be extracted using the amplitudes of temperature oscillation and phase difference across the two faces 154 and 152, by using a known solution to the heat diffusion equation for a system experiencing periodic heating.

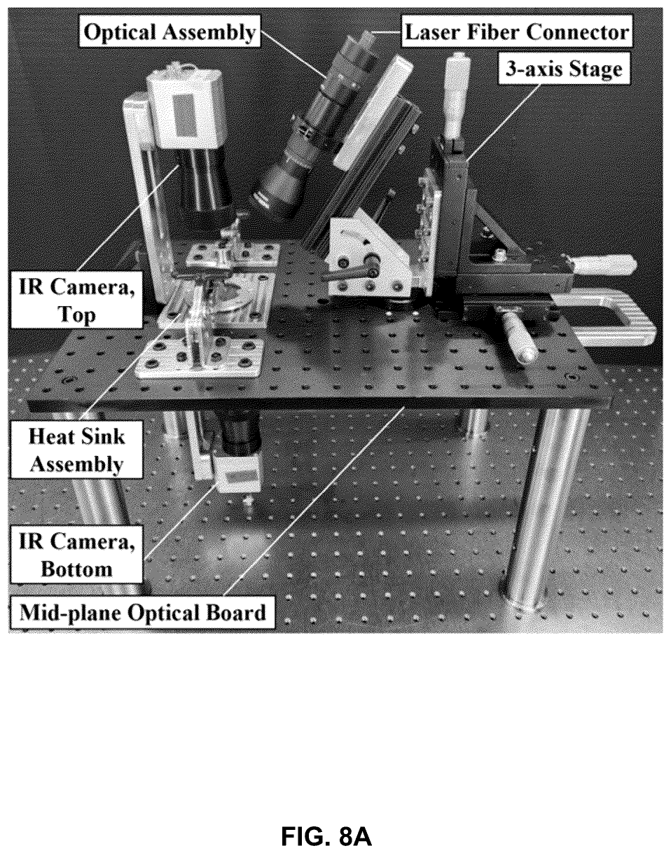

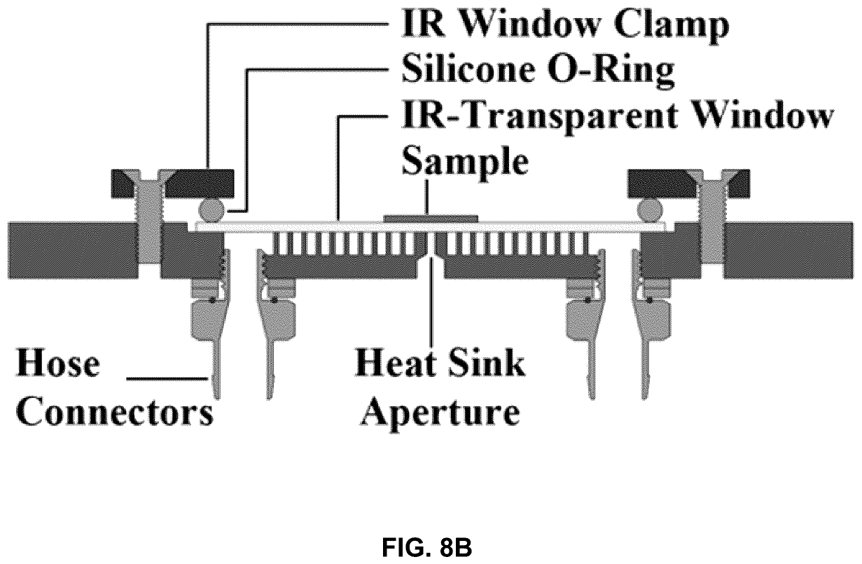

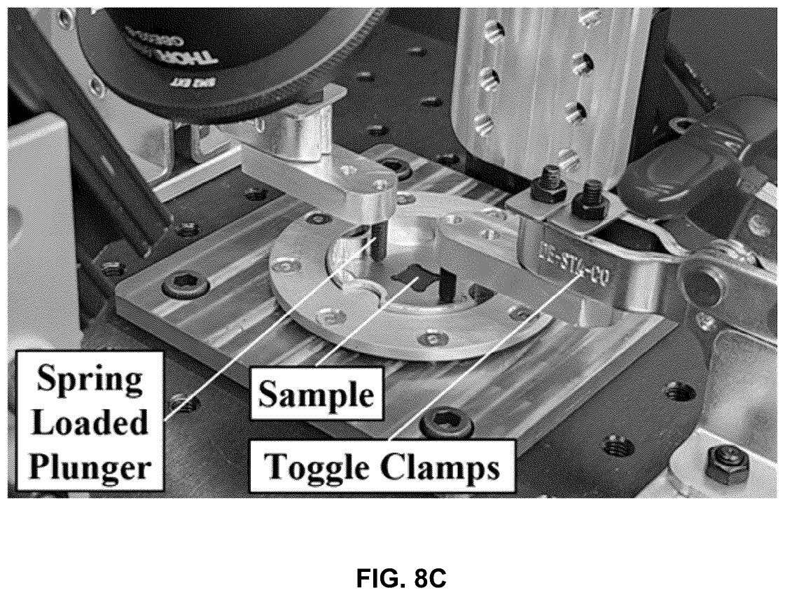

An experimental facility was developed to operate on the principles of this metrology technique, as shown in FIGS. 8A-8C. FIG. 8A depicts an overview of an experimental measurement system configured to measure interfacial thermal resistance between two bonded material layers of a sample. FIG. 8B depicts a schematic sectional view of a subset of the experimental measurement system of FIG. 8A. FIG. 8C depicts a photographic overview of an assembled subset of the experimental measurement system of FIG. 8A, showing portions including the toggle clamps, spring loaded plunger assembly, and the adapter plates.

The main components of the system include two IR cameras, an optical assembly to condition the laser beam before it is made incident on the sample, and a heat sink assembly similar to the heat sink assembly described with regard to FIG. 8A. The IR cameras in this setup may be, for example, Optris PI640i cameras manufactured by Optris Gmbh of Berlin, Germany, used with a 12 degree×9 degree optic which yields a maximum spatial resolution of ˜30 μm/pixel. The sensor resolution is 640×480 pixels but drops to 640×120 pixels when operating at their maximum frame rate of 125 Hz. The IR cameras are mounted to a mid-plane optical board using machined posts, one on either side of the heat sink. The top IR camera has a full view of the top surface of the sample, while the bottom IR camera must view the bottom surface of the sample via the aperture (e.g., around 1 mm in diameter) in the heat sink. The spatial resolution of the cameras is sufficiently high for several pixels to be recorded by the bottom IR camera through this aperture. Since the temperature gradient is constrained in the vertical direction, typically, a 1D transient temperature profile is recorded as an average from a 3×3 or 5×5 grid of pixels. The averaging across such a grid smoothens the effects of spatial noise in the measurement.

The heat sink assembly consists of the two-part heat sink, toggle clamps, and spring-loaded plungers that allow the sample to be pressed against the IR-transparent window (e.g., a germanium window). The window is pressed against the copper portion using an annular clamp (e.g., an annular aluminum clamp) and an O-ring (e.g., a silicone O-ring). The O-ring serves multiple functions: first, it allows for the cooling fluid to be sealed within the microchannels of the heat sink, and second, it provides relief to the potentially brittle window from any excess torque that may be applied during the assembly of the annular clamp.

The sample is heated periodically using a laser generator, such as a bench-top diode laser system (e.g., a model RDS3 manufactured by RPMC Lasers Inc. of O'Fallon, MO, set to max. 70 W, continuous wave, 976 nm). The periodic heating was achieved by modulating the continuous wave output of the laser (via a square-wave trigger signal generated in LabView). This fiber-coupled laser was mounted to a series of optical components using a sub-miniature, version A (SMA) adapter. The optical elements include a beam collimator, a beam expander, and a beam shaper (with an engineered diffuse surface). The laser output downstream of this optical assembly is a collimated beam with a uniform top-hat intensity distribution, with a beam size of ˜15 mm in diameter. FIG. 8C shows the 10×10 mm sample installed at the center of the germanium window and being pressed against it by the spring-loaded plungers attached to the toggle clamps. Samples that are not sufficiently opaque in the infrared spectrum are coated on both faces with a thin layer of colloidal graphite to increase the emissivity and enable accurate temperature measurements.

The entire experimental facility may be fully enclosed in a laser enclosure constructed using, for example, 1 mm thick black anodized aluminum panels. After the sample is installed in the experimental facility, temperature data is collected via LabView. The Optris Gmbh PI640i cameras are capable of recording analog input signals and outputting them simultaneously with the measured temperature. The laser trigger signal that modulates the laser is also input into both IR cameras. Then, along with the temperature signals from the cameras, the laser trigger signal is also recorded on the same clock as the temperature signal, as an output from each of the IR cameras. The phase differences for the two individual cameras are then calculated with respect to the laser trigger signal from each camera, which allows for the two cameras to operate independently, and accounts for any un-foreseen temporal synchronization error or jitter between the two cameras. This process of capturing the phase delay relative to the laser trigger improves the precision of the measurements.

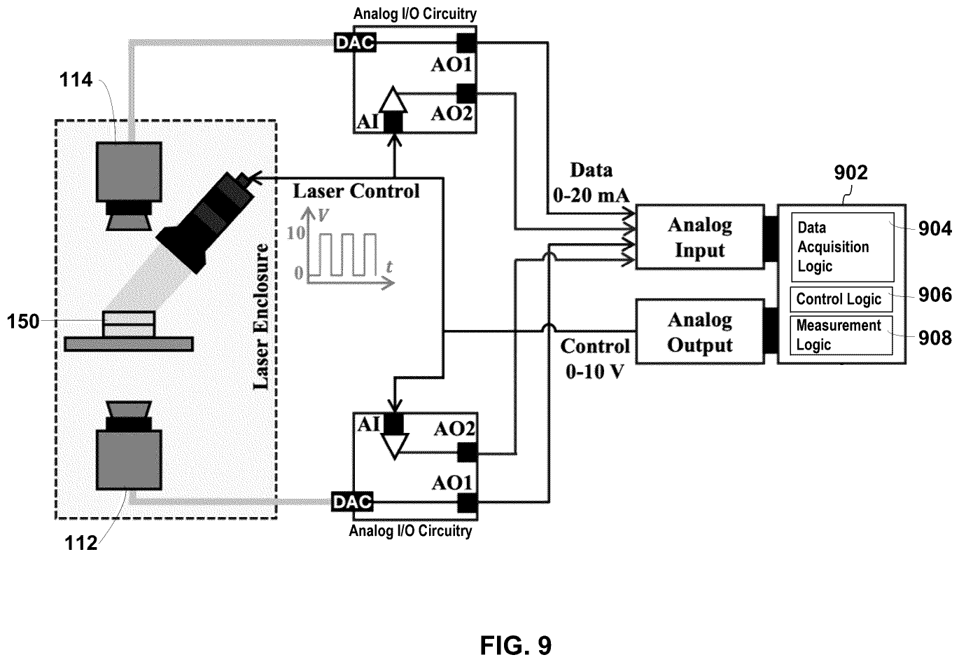

FIG. 9 illustrates a fourth example of the metrology system 100. The system 100 may include computing hardware 902. The computing hardware 902 may include and/or execute data acquisition logic 904, control logic 906, and/or measurement logic 908.

The data acquisition logic 904 may receive signals generated by the first thermal measurement device 112 and second thermal measurement device 114, or intervening circuitry which filters and/or converts the signals into a different format. For example, the system 100 may include analog to digital circuitry which received digital signals from the thermal measurement devices 112,114. In other examples, the thermal measurement devices 112,114 may interface directly with the computing hardware 902 using analog or digital signals.

The control logic 906 may control the heat sink 108 and/or the heat source 110. For example, the control logic 906 may cause the heat source to applied to the stack 150, as in the various examples and embodiments described herein. For example, the control logic 906 may cause the periodic heat output from the heat source. Also, the control logic 906 may cause the heat sink to control how cooling is applied to the stack 150 as in the various examples and embodiments described herein.

The measurement logic 908 may perform the various measurements and calculations described herein. The measurement logic 908 may generate, based on measurements acquired over time from the first thermal measurement device and the second thermal measurement device, a thermal conductance measurement across the interface between the first material layer bonded to the second material layer. To generate the thermal conductance measurement, the measurement logic 908 may determine, based on the measurements acquired over time from the first thermal measurement device and the second thermal measurement device, an absolute temperature measurement and a phase difference measurement. The measurement logic 908 may determine, based on the absolute temperature measurement and the phase difference measurement, the thermal conductance across the interface between the first material layer bonded to the second material layer. For example, measurement logic 908 may access a model which receives, among other possible parameters, the absolute temperature measurement and the phase difference measurement, the model may apply a heat diffusion equation to provide the thermal conductance based on a previous established relationships between absolute heat, phase difference measurements, and/or temperature measurements.

The temperature measurements and/or the thermal conductance measurement may be stored in memory, output to a display device, and/or sent over a communications network.

Depending on the implementation, the thermal measurement devices 112,114 may output temperature measurements directly, or other values, such as IR intensity measurements. In examples where the thermal measurement devices do not output temperature measurements directly, the data acquisition logic 908 may convert the measurements from the thermal measurement devices into temperature measurements. Alternatively, the conversion may be performed by other logic which interfaces with the data acquisition logic.

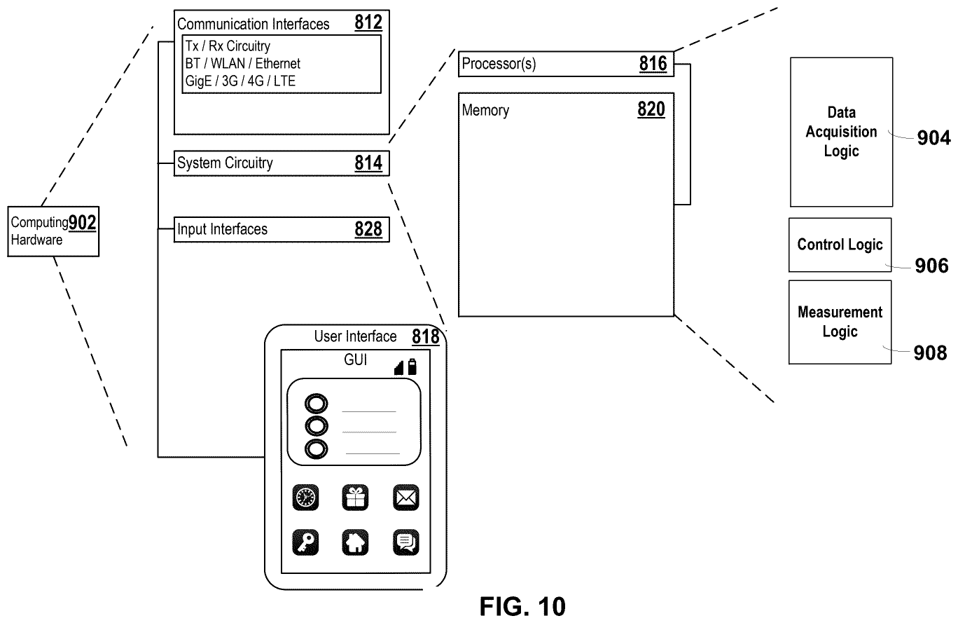

FIG. 10 illustrates an example of computing hardware 902 for the metrology system 100. The computing hardware 902 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations the data acquisition logic 904, control logic 906, measurement logic 908, and/or other operations to operate the components of the system described. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the data acquisition logic 904, control logic 906, measurement logic 908, and/or other instructions to operate the components of the system described herein. Alternatively or in addition, the memory may include any other component or sub-component of the computing hardware 902 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the computing hardware 902 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The computing hardware 902 may be implemented in many different ways. In some examples, the computing hardware 902 may be implemented with one or more logical components. For example, the logical components of the computing hardware 902 may be hardware or a combination of hardware and software. The logical components may the data acquisition logic 904, control logic 906, and/or measurement logic 908. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the computing hardware 902 and its logic and data structures may be stored on, distributed across, or read from one or more types of computer readable storage media. Examples of the computer readable storage medium may include a hard disk. a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the computing hardware 902 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the computing hardware may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relation to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

What is claimed is:

1. A metrology system for measuring a thermal conductance across an interface between a first material layer bonded to a second material layer, wherein the first material layer includes a first outward facing and the second material layer includes a second outward facing surface, the metrology system comprising:
a heating source configured to provide periodically varying heat input uniformly across the first outward facing surface;
a heat sink in contact with the second outward facing surface;
a first thermal measurement device configured to measure a temperature of the first outward facing surface;
a second thermal measurement device configured to measure a temperature of the second outward facing surface; and
a processor configured to:
generate, based on a plurality of measurements acquired over time from the first thermal measurement device and the second thermal measurement device, a thermal conductance measurement across the interface between the first material layer bonded to the second material layer.

2. The metrology system of claim 1, wherein to generate the thermal conductance measurement, the processor is further configured to:
determine, based on the plurality of measurements acquired over time from the first thermal measurement device and the second thermal measurement device, an absolute temperature measurement and a phase difference measurement; and
determine, based on the absolute temperature measurement and the phase difference measurement, the thermal conductance across the interface between the first material layer bonded to the second material layer.

3. The metrology system of claim 1, wherein the first thermal measurement device and the second thermal measurement device do not contact the first outward facing surface and the second outward facing surface, respectively.

4. The metrology system of claim 1, wherein the temperature measurement from first thermal measurement device and the temperature measurement from the second thermal measurement device are each provided as a corresponding analog signal or a corresponding digital signal.

5. The metrology system of claim 4, wherein the temperature measurement from first thermal measurement device and the temperature measurement from the second thermal measurement device are each based on a corresponding infrared emission from the first outward facing surface and the second outward facing surface, respectively.

6. The metrology system of claim 1, wherein the first thermal measurement device comprises a first infrared camera or a first infrared pyrometer,
wherein the second thermal measurement device comprises a second infrared camera or a second infrared pyrometer.

7. The metrology system of claim 1, wherein the heating source and the heat sink are configured to generate a uniform transient thermal gradient across the first material layer and second material layer.

8. The metrology system of claim 1, wherein the heating source covers an entirety of the first outward facing surface and the heat sink covers an entirety of the second outward facing surface.

9. The metrology system of claim 1, wherein the heating source comprises non-contact laser generator configured to direct a laser onto the first outward facing surface.

10. The metrology system of claim 1, wherein the heat sink is positioned between the second outward facing surface and the second thermal energy measurement device,
wherein the heatsink comprises an aperture,
wherein the second thermal measurement device receives infrared emission from the second outward facing surface via the aperture.

11. The metrology system of claim 1, wherein the heat sink includes:
an infrared transparent material layer positioned to contact the second outward facing surface, and
a heat dissipation material layer contacting the infrared transparent material layer.

12. The metrology system of claim 11, wherein the heat dissipation material layer includes an aperture therethrough to expose a portion of the infrared transparent material layer from an externally facing surface of the heat sink positioned opposite to the second outward facing surface.

13. The metrology system of claim 11, wherein the infrared transparent material layer includes germanium.

14. The metrology system of claim 11, wherein the heat dissipation material layer includes copper.

15. A method of measuring a thermal conductance across an interface between a first material layer bonded to a second material layer, wherein the first material layer includes a first outward facing surface and a first interface surface, and the second material layer includes a second outward facing surface and a second interface surface configured to interface with the first interface surface, wherein a heat sink is positioned in contact with the second outward facing surface and includes an aperture therethrough to expose a portion of the second outward facing surface, the method comprising:
placing a heatsink on the second outward surface of the second material layer;
applying a uniform heat input to the first outward facing surface of the first material layer;
measuring temperatures of the first outward facing surface over time based on infrared emission of the first outward facing surface, the temperatures measured of the first outward facing surface providing a first temperature signal;
measuring temperatures of the second outward facing surface over time based on the infrared emission of the second outward facing surface, the temperatures measured of the first outward facing surface providing a first temperature signal; and
capturing, in a memory, the first temperature signal and the second temperature signal.

16. The method of claim 15, outputting at least one of, a phase difference of the first temperature signal and the second temperature signal, a amplitude difference of the first temperature signal and a second temperature signal, a thermal conductance across an interface, or a combination thereof.

17. The method of claim 15, wherein applying a uniform heat input to the first outward facing surface of the first material layer comprises periodically varying a temperature of the heat input over time.

18. The method of claim 15, further comprising aiming a first infrared capture device at the first outward facing surface and aiming a second infrared capture device at the second outward facing surface,
wherein the temperatures of the first outward facing surface are measured based on a first infrared signal from the first infrared capture device and the temperatures of the second outward facing surface are measured based on a second infrared signal from the second infrared capture device.

19. The method of claim 18, wherein aiming a second infrared capture device at the second outward facing surface comprises aiming the second infrared capture device through an aperture in the heat sink.
